(19) United States
(12) Patent Application Publication
(10) Pub. No.: US 2008/0094362 A1
(43) Pub. Date: Apr. 24, 2008

(54) KEYBOARD WITH KEYS ARRANGED IN PAIRS AND HANDHELD ELECTRONIC APPARATUS INCORPORATING THE SAME

(76) Inventor: Ta-Yuan Lee, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/837,701

(22) Filed: Aug. 13, 2007

(30) Foreign Application Priority Data
Oct. 20, 2006 (TW) 095138911

(51) Int. Cl. G06F 3/02

(52) U.S. Cl. 345/168

(57) ABSTRACT

The invention provides a keyboard including a plurality of user-operable keys and a processor. The user-operable keys include a first key and a second key. The processor generates a first key signal in response to the key-in action of the first key, generates a second key signal in response to the key-in action of the second key, and generates the second key signal in response to the key-in action of the second key together with the first key. The first key signal represents the first key. The second key signal represents the second key.

### BACKGROUND OF THE INVENTION

1. Field of the Invention

This invention relates to a keyboard which comprises keys arranged in pairs and a handheld electronic apparatus that incorporates the keyboard. Particularly, the keyboard selectively generates a key signal in response to the key-in action of a key or a pair of keys.

2. Description of the Prior Art

As a main inputting tool of many electronic devices, keyboards are designed for providing convenience to users who operate the electronic devices. Without suitable designs, users cannot easily operate keys in the process of using keyboards, and that may cause fatigue in their arms or hands. Manufacturers did not take the design of keyboards into account before. However, as “humanized products” become more and more popular, a keyboard conforming to ergonomics becomes a key point in designing electronic products. After conducting long-term research and designing, most keyboards nowadays can make users feel comfortable and let their wrists or palms feel relaxed.

Nevertheless, the spaces between keys are still narrow in electric products; it is easy to key in wrong data. Referring to FIG. 1, FIG. 1 is the schematic diagram of a handheld electronic apparatus 1 according to the prior art. The handheld electronic apparatus 1 comprises a plurality of user-operable keys 10. The spaces between the user-operable keys 10 are narrow, so it is possible to press undesired or redundant keys.

Furthermore, for small electronic devices (e.g., smart phones), because the keys of all English alphabets cannot be fitted in a finite space, each key on a keyboard is often representative of a plurality of alphabets. Users often need to press a key several times for choosing a correct alphabet. Therefore, more efficient operation of keys can be achieved if keys of all English alphabets can be fitted in a keyboard by different arrangement of the keys.

Therefore, to solve the above problems, a scope of the invention is to provide a keyboard with keys arranged in pairs and a handheld electronic apparatus that incorporates the keyboard.

### SUMMARY OF THE INVENTION

The keyboard, according to the first preferred embodiment of the invention, comprises a plurality of user-operable keys. The plurality of user-operable keys comprises a first key and a second key. The second key is disposed adjacent to the first key, and they are arranged in a row. The keyboard also comprises a processor. The processor generates a first key signal representative of the first key in response to the key-in action of only the first key, and it generates a second key signal representative of the second key in response to the key-in action of only the second key. The processor generates the second key signal in response to the key-in action of the second key together with the first key.

A handheld electronic apparatus, according to the second preferred embodiment of the invention, comprises a housing, a keyboard, and a processor. The keyboard is mounted in the housing and comprises a plurality of user-operable keys. The plurality of user-operable keys comprises a first key and a second key. The second key is disposed adjacent to the first key, and they are arranged in a row. The processor generates a first key signal representative of the first key in response to the key-in action of only the first key. The processor generates a second key signal representative of the second key in response to the key-in action of only the second key. The processor generates the second key signal in response to the key-in action of the second key together with the first key.

The third preferred embodiment of the invention is an inputting method of a keyboard. The keyboard comprises a plurality of user-operable keys arranged into an array of M rows. M is an integer larger than one. The keys in at least one row of keys in the M rows of keys are adjacent to each other and are arranged continuously. The at least one row of keys comprises a first key and a second key. The second key is disposed adjacent to the first key. When a user presses the first key, the method determines whether the key-in action of the second key is together with the key-in action of the first key. If the judging result is YES, a second key signal is generated in response to the key-in action of the second key together with the first key. If the judging result is NO, a first key signal is generated in response to the key-in action of only the first key. When the user presses the second key, the second key signal will be generated in response to the key-in action of only the second key. The first key signal is representative of the first key. The second key signal is representative of the second key.

A keyboard, according to the fourth preferred embodiment of the invention, comprises a plurality of user-operable keys. The plurality of user-operable keys are arranged into an array of M rows. M is an integer larger than one. At least some of the keys in at least one row among the M rows of keys is interlaced with wide keys and narrow keys.

The advantage and spirit of the invention may be understood by the following recitations together with the appended drawings.

### BRIEF DESCRIPTION OF THE APPENDED DRAWINGS

FIG. 1 is the schematic diagram of a handheld electronic apparatus according to the prior art.

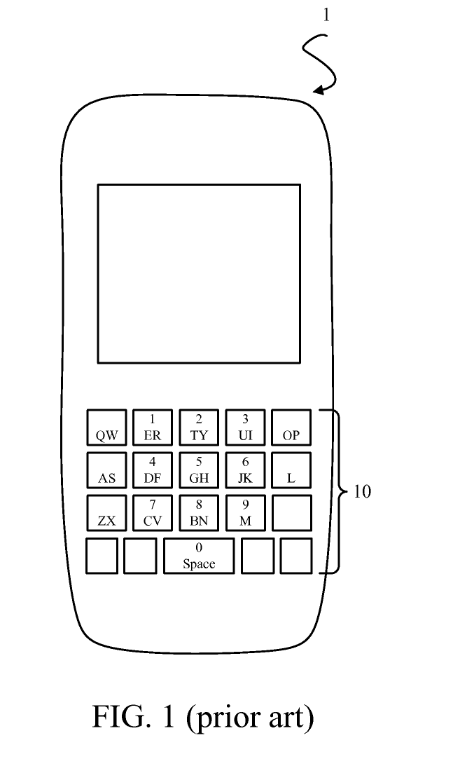

FIG. 2A is the schematic diagram of a handheld electronic apparatus according to the first preferred embodiment of the invention.

FIG. 2B is the functional block diagram of the handheld electronic apparatus shown in FIG. 2A.

FIG. 3 is the schematic diagram of a handheld electronic apparatus according to the second preferred embodiment of the invention.

FIG. 4 is the schematic diagram of a handheld electronic apparatus according to the second preferred embodiment of the invention.

FIG. 5 is the schematic diagram of a handheld electronic apparatus according to the second preferred embodiment of the invention

FIG. 6 is the flow chart of the inputting method according to the third preferred embodiment of this invention.

FIG. 7 is another flow chart of the inputting method according to the third preferred embodiment of this invention.

### DETAILED DESCRIPTION OF THE INVENTION

The scope of this invention is to provide a keyboard which comprises keys arranged in a pair and a handheld electronic apparatus that incorporates the keyboard. Particularly, the handheld electronic apparatus selectively generates a key signal in response to the key-in action of a key or a pair of keys. The preferred embodiment of this invention will be described below to fully explain the characteristics, spirit, advantages, and convenience of the invention.

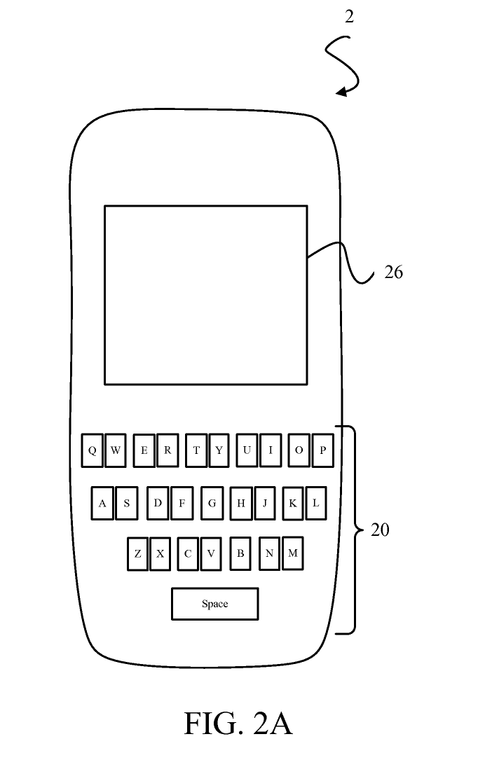

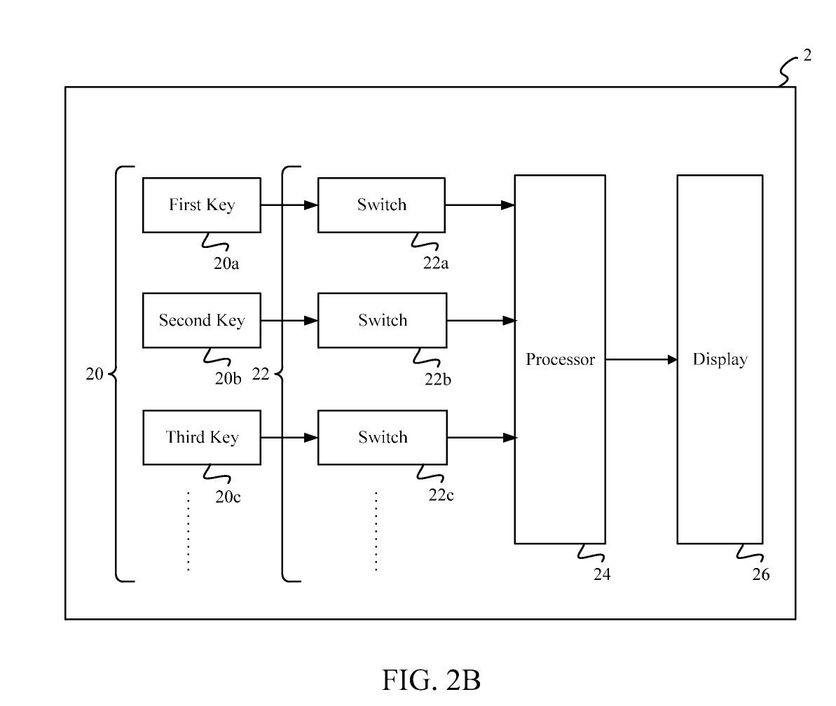

Please refer to FIG. 2A. FIG. 2A is the schematic diagram of a handheld electronic apparatus 2 according to the first preferred embodiment of the invention. The handheld electronic apparatus 2 comprises a plurality of keys 20. The plurality of keys 20 are arranged in pairs and have the same size. The plurality of keys 20 can be arranged in any form of a keyboard or a standard keyboard. In this embodiment, a QWERTY array is taken as an example.

The first pair of keys on the left side of the handheld electronic apparatus 2 includes two keys, Q and W, of the same size. The first pair of keys on the right side of the handheld electronic apparatus 2 also includes two keys, O and P, of the same size. Assume a user operates the handheld electronic apparatus 2 with two hands. If the user's left thumb presses the keys 20 from left to right, it is easy to press W together with Q. Similarly, if the user's right thumb presses the keys 20 from right to left, it is easy to press O together with P. To solve these problems, the invention provides a control method of the keys 20.

Please refer to FIG. 2B. FIG. 2B is the functional block diagram of the handheld electronic apparatus 2 shown in FIG. 2A. The plurality of user-operable keys 20 are arranged into an array, and each of them respectively corresponds to one key in FIG. 2A. The first key 20a corresponds to the key Q, the second key 20b corresponds to the key W, the third key 20c corresponds to the key E, and so on. As shown in FIG. 2A, the second key 20b is disposed adjacent to the first key 20a, and the third key 20c is disposed adjacent to the second key 20b. A first distance between the first key 20a and the second key 20b is shorter than a second distance between the second key 20b and the third key 20c.

Please refer to FIG. 2A and FIG. 2B. The key Q is the first key of the first row of keys arranged from left to right. The key W is the second key of the first row of keys arranged from left to right. The key E is the third key of the first row of keys from arranged left to right. Similarly, the key P is the first key of the first row of keys arranged from right to left, the key O is the second key of the first row of keys arranged from right to left, and the key I is the third key of the first row of keys arranged from right to left.

Similarly, as shown in FIG. 2B, the first key 20a corresponds to a first key switch 22a, the second key 20b corresponds to a second key switch 22b, and the third key 20c corresponds to a third key switch 22c. Every key switch 22 is respectively connected to a processor 24. The processor 24 generates a first key signal in response to the key-in action of only the first key 20a. Similarly, the processor 24 generates a second key signal in response to the key-in action of only the second key 20b. Furthermore, the processor 24 generates a third key signal in response to the key-in action of only the third key 20c. The first key signal is representative of a first key, such as Q. The second key signal is representative of a second key, such as W. The third key signal is representative of a third key, such as E.

When a user presses a key 20 of the plurality of keys 20, a corresponding switch 22 is activated to generate and output a corresponding key-in signal to the processor 24. In response to the key-in signal, the processor 24 generates and outputs a corresponding key signal to a display 26. The keys 20 on the left side of the first row of the keys 20 of the handheld electronic apparatus 2 are taken as an example. When a user presses the key Q, the corresponding switch 22 will be activated. The processor 24 then generates and outputs a key-in signal representative of Q to the display 26.

Similarly, when a user presses the key W, the corresponding switch 22 will be activated. The processor 24 then generates and outputs a key-in signal representative of W. However, when the user presses the key W by his/her left thumb, it is possible to accidentally press the key Q at the same time. When the processor 24 detects that the switches corresponding to Q and W are activated at the same time, the processor 24 will generate and output the key-in signal representative of W.

When a user presses the key E, the corresponding switch 22 will be activated. The processor 24 then generates and outputs a key-in signal representative of E to the display 26. Similarly, when the user presses the key E by his/her left thumb, it is possible to accidentally press the key W at the same time. To solve this problem, the invention can make the following two arrangements. First, the distance between the keys W and E can be increased as shown in FIG. 2A to avoid accidentally pressing two keys at the same time. Second, when the processor 24 detects that the switches corresponding to the keys W and E are activated the same time, the processor 24 can only generate and output the key-in signal representative of E. The two arrangements can also be carried out together. The other keys corresponding to a left hand, such as the keys A, S, etc., can be arranged in the same way.

The keys P and O located on the right side of the keys 20 correspond to a right hand. When a user presses the key P, a corresponding switch 22 will be activated. The processor 24 then generates and outputs the key-in signal representative of P to the display 26. Similarly, when a user presses the key O, a corresponding switch 22 will be activated. The processor 24 then generates and outputs the key-in signal representative of O to the display 26. As mentioned before, when the user presses the key O by his/her right thumb, it is possible to accidentally press the key P at the same time. When the processor 24 detects that the switches corresponding to the keys O and P are activated at the same time, the processor 24 will only generate and output the key signal representative of O.

When a user presses the key I, a corresponding switch 22 will be activated. The processor 24 then generates and outputs the key-in signal representative of I to the display 26. Similarly, when the user presses the key I by his/her right thumb, it is possible to accidentally press the key O at the same time. To solve this problem, the invention can make the following two arrangements, too. First, the distance between the keys I and O can be increased as shown in FIG. 2A to avoid accidentally pressing two keys at the same time. Second, when the processor 24 detects that the switches corresponding to the keys I and O are activated at the same time, the processor 24 can only generate and output the key-in signal representative of I. The other keys corresponding to a right hand, such as the keys L, K, etc., can be arranged in the same way.

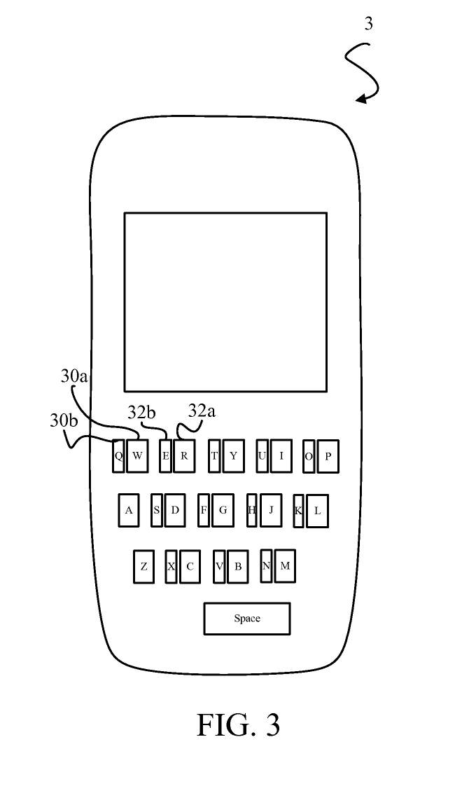

Please refer to FIG. 3. FIG. 3 is the schematic diagram of a handheld electronic apparatus 3 according to a second preferred embodiment of the invention. The handheld electronic apparatus 3 comprises a plurality of user-operable keys. The wide key of each pair of the keys is disposed on the right side of a corresponding narrow key, so that a user can operate the keys with his/her right hand alone. The plurality of keys are arranged into a QWERTY array. The arrangement of the QWERTY array is not affected by the widths of the keys.

The first pair of keys on the left side of the first row of keys of the handheld electronic apparatus 3 is taken as an example. The first pair of keys comprises a first key 30b and a second key 30a. The first key 30b is a narrow key representative of Q. The second key 30a is a wide key representative of W. The handheld electronic apparatus 3 further comprises a third key 32b. The third key 32b is a narrow key representative of E. The first key 30b defines a longitudinal direction. The second key 30a is disposed adjacent to the first key 30b along the elongated direction. A first distance between the first key 30b and the second key 30a is shorter than a second distance between the second key 30a and the third key 32b.

When a user presses the first key 30b, a processor generates a key signal Q in response to the key-in action of only the first key 30b. When the user presses the second key 30a, the processor generates a key signal W in response to the key-in action of only the second key 30a. When the user presses the first key 30b together with the second key 30a, the processor generates the key signal Q in response to the key-in action of the first key 30b together with the second key 30a. When the user presses the second key 30a together with the third key 32b, the processor generates the key signal W in response to the key-in action of the second key 30a together with the third key 32b.

The third key 32b is also a first key of a second pair of keys. The second pair of keys comprises the first key 32b and another second key 32a. The second key 32a is representative of the key R. When the user presses the first key 32b and the second key 32a separately, the processor will generate a key signal representative of E and a key signal representative of R separately. When the user presses the first key 32b together with the second key 32a at the same time, the processor generates a key signal representative of E. Similarly, the method of managing the other keys, such as T/Y and U/I, is the same with that of Q/W.

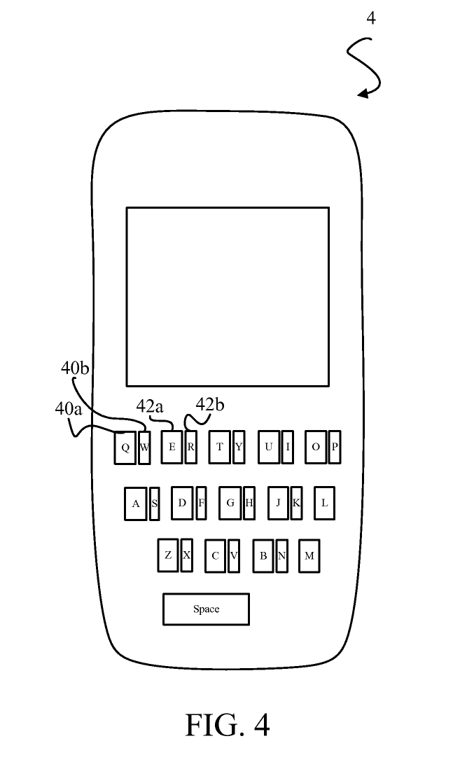

Please refer to FIG. 4. FIG. 4 is the schematic diagram of a handheld electronic apparatus 4 according to the second preferred embodiment of the invention. The handheld electronic apparatus 4 comprises a plurality of user-operable keys. The wide key of each pair of the keys is disposed adjacent to the left side of a corresponding narrow key, so that a user can operate the keys with his/her left hand alone. The plurality of keys are arranged into a QWERTY array.

The first pair of the keys on the left side of the first row of keys of the handheld electronic apparatus 4 is taken as an example. The first pair of keys comprises a first key 40a and a second key 40b. The first key 40a is a wide key representative of Q, and the second key 40b is a narrow key representative of W. The handheld electronic apparatus 4 further comprises a third key 42a. The third key 42a is a wide key representative of E. The first key 40a defines an elongated direction. The second key 40b is disposed adjacent to the first key 40a along the elongated direction. A first distance between the first key 40a and the second key 40b is shorter than a second distance between the second key 40b and the third key 42a.

When a user presses the first key 40a, a processor generates a key signal Q in response to the key-in action of only the first key 40a. When the user presses the second key 40b, the processor generates a key signal W in response to the key-in action of only the second key 40b. When the user presses the first key 40a together with the second key 40b, the processor generates the key signal W in response to the key-in action of the first key 40a together with the second key 40b. When the user keys in the second key 40b together with the third key 42a, the processor generates the key signal E.

The third key 42a is also a first key of a second pair of keys at the same time. The second pair of keys comprises the first key 42a and another second key 42b. The second key 42b is representative of the key R. When the user presses the first key 42a and the second key 42b separately, the processor will generate a key signal representative of E and a key signal representative of R separately. When the user presses the first key 42a together with the second key 42b, the processor generates a key signal R. Similarly, the method of managing the other keys, such as T/Y and U/I, is the same with that of Q/W.

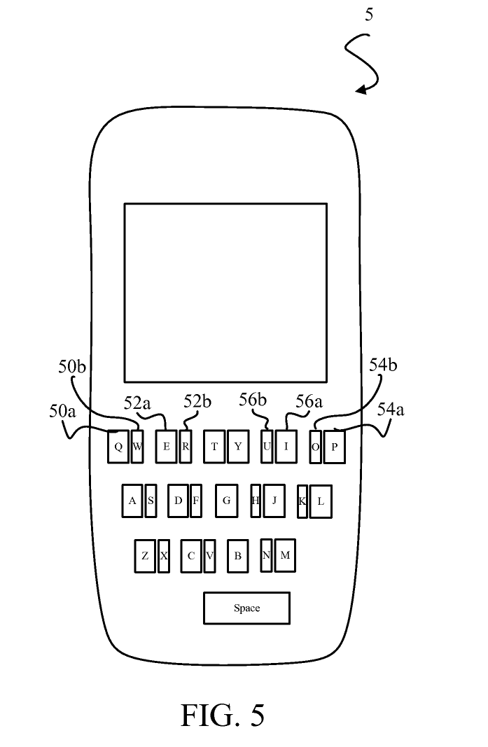

Please refer to FIG. 5. FIG. 5 is the schematic diagram of a handheld electronic apparatus 5 according to the second preferred embodiment of the invention. The handheld electronic apparatus 5 comprises a plurality of user-operable keys. Suppose the keyboard has a virtual centerline. The centerline passes the interval between the keys T and Y, and the right side of the keys G and B. The keys on the left side of the centerline correspond to the keys operated by a left hand. The keys on the right side of the centerline correspond to the keys operated by a right hand. The wide key of each pair of keys on the right side of the centerline is disposed on the right side of a corresponding narrow key so that a user can operate the keys with his/her right hand alone. Similarly, the wide key of each pair of keys on the left side of the centerline is disposed on the left side of a corresponding narrow key so that a user can operate the keys with his/her left hand alone. The plurality of keys are arranged into a QWERTY array. The arrangement of the QWERTY array is not affected by the widths of the keys.

The first pair of keys on the right side of the first row of keys of the handheld electronic apparatus 5 is taken as an example. The first pair of keys comprises a first key 54a and a second key 54b. The first key 54a is a wide key representative of P, and the second key 54b is a narrow key representative of O. The handheld electronic apparatus 5 further comprises a third key 56a. The third key 56a is a wide key representative of I. The first key 54a defines an elongated direction. The second key 54b is disposed adjacent to the first key 54a along the elongated direction. A first distance between the first key 54a and the second key 54b is shorter than a second distance between the second key 54b and the third key 56a.

When a user presses the first key 54a, a processor generates a key signal representative of P in response to the key-in action of only the first key 54a. When the user presses the second key 54b, the processor generates a key signal representative of O in response to the key-in action of only the second key 54b. When the user presses the first key 54a together with the second key 54b, the processor generates a key signal representative of O in response to the key-in action of the first key 54a together with the second key 54b. When the user presses the second key 54b together with the third key 56a, the processor generates a key signal representative of I.

The third key 56a is also a first key of a second pair of keys. The second pair of keys comprises the first key 56a and another second key 56b. The second key 56b is representative of the key U. When the user presses the first key 56a and the second key 56b separately, the processor will generate a key signal representative of I and a key signal representative of U separately. When the user presses the first key 56a together with the second key 56b, the processor generates a key signal representative of U. Similarly, the method of managing the other keys, such as K/L and H/J, is the same with that of O/P.

The first pair of keys on the left side of the first row of keys of the handheld electronic apparatus 5 is taken as an example. The first pair of keys comprises a first key 50a and a second key 50b. The first key 50a is a wide key representative of Q, and the second key 50b is a narrow key representative of W. The handheld electronic apparatus 5 further comprises a third key 52a. The third key 52a is a wide key representative of E. The first key 50a defines an elongated direction. The second key 50b is disposed adjacent to the first key 50a along the elongated direction. A first distance between the first key 50a and the second key 50b is shorter than a second distance between the second key 50b and the third key 52a.

When a user presses the first key 50a, a processor generates a key signal representative of Q in response to the key-in action of only the first key 50a. When the user presses the second key 50b, the processor generates a key signal representative of W in response to the key-in action of only the second key 50b. When the user presses the first key 50a together with the second key 50b, the processor generates the key signal representative of W in response to the key-in action of the first key 50a together with the second key 50b. When the user presses the second key 50b together with the third key 52a, the processor generates a key signal representative of E.

The third key 52a is also a first key of a second pair of keys. The second pair of keys comprises the first key 52a and another second key 52b. The second key 52b is representative of the key R. When the user presses the first key 52a and the second key 52b separately, the processor will generate a key signal representative of E and a key signal representative of R separately. When the user presses the first key 52a together with the second key 52b, the processor generates the key signal representative of R. Similarly, the method of managing the other keys, such as A/S and D/F, is the same with that of Q/W.

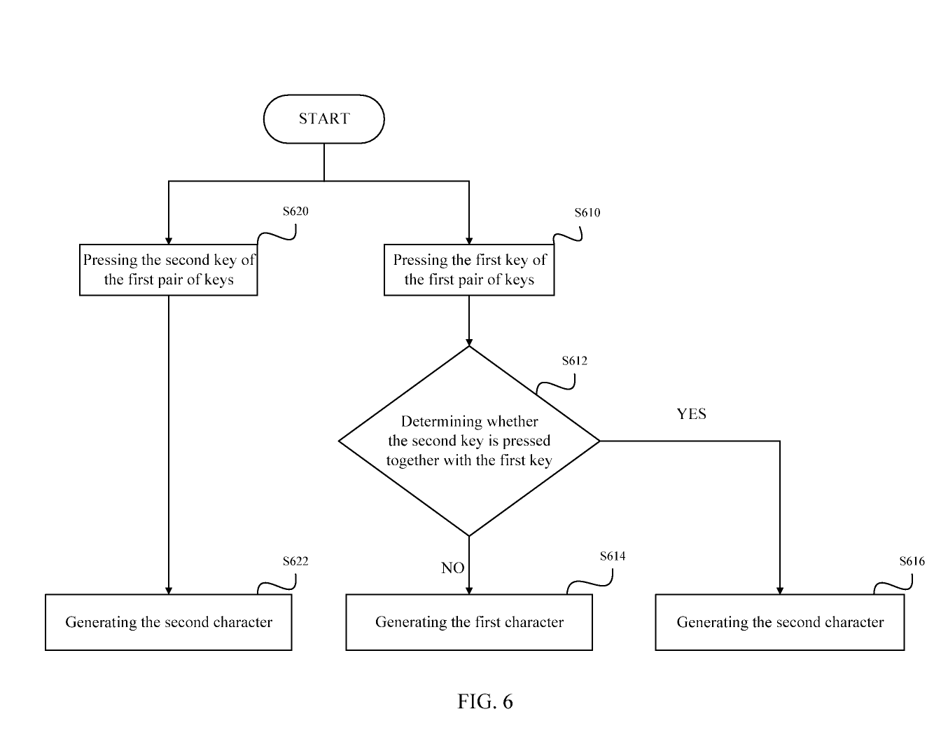

Please refer to FIG. 6; FIG. 6 is the flow chart of an inputting method according to a third preferred embodiment of this invention. The inputting method is an inputting method for operating a keyboard. According to the third preferred embodiment, the inputting method of the invention comprises the following steps:

Step S610: pressing a first key of a first pair of keys, wherein keys in the first pair of keys are adjacent to each other and arranged in a row;

Step S612: determining whether a second key of the first pair of keys is pressed together with the first key of the first pair of keys; if the judgment is NO, performing step S614, and if the judgment is YES, performing step S616;

Step S614: generating a first key in response to the key-in action of only the first key of the first pair of keys;

Step S616: generating a second key in response to the key-in action of the first key of the first pair of keys together with the second key of the first pair of keys;

Step S620: pressing the second key of the first pair of keys; and

Step S622: generating the second key in response to the key-in action of only the second key of the first pair of keys.

The first key of the first pair of keys may be a wide key, and the second key of the first pair of keys is a narrow key. The first key and the second key of the first pair of keys are adjacent to each other and arranged consecutively. The first key of the first pair of keys is the first one in a row of a plurality of keys arranged from left to right. The second key of the first pair of keys is the second one in the row of the plurality of keys arranged from left to right.

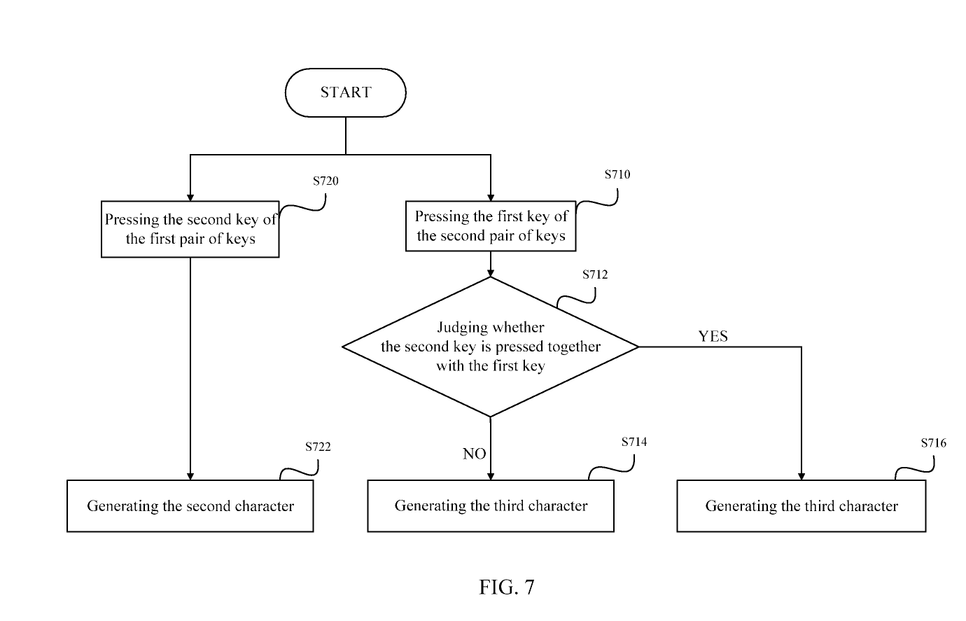

Please refer to FIG. 7. FIG. 7 is another flow chart of the inputting method according to the third preferred embodiment of this invention. According to the third preferred embodiment, the inputting method of the invention comprises the following steps:

Step S710: pressing a first key of a second pair of keys, wherein keys in the second pair of keys are adjacent to each other, and the second pair of keys are adjacent to the first pair of keys and arranged in a row;

Step S712: determining whether a second key of the first pair of keys is pressed together with the first key of the second pair of keys, if the judgment is NO, performing step S714, and if the judgment is YES, performing step S716;

Step S714: generating a third key in response to the key-in action of only the first key of the second pair of keys;

Step S716: generating the third key in response to the key-in action of the second key of the first pair of keys together with the first key of the second pair of keys;

Step S720: pressing the second key of the first pair of keys; and

Step S722: generating a second key in response to the key-in action of only the second key of the first pair of keys.

The above first key of the second pair of keys is a wide key, and the second key of the first pair of keys is a narrow key. The first key of the second pair of keys and the second key of the first pair of keys are adjacent to each other and arranged continuously. The first key of the second pair of keys is the third one in a row of a plurality of keys arranged from left to right. The second key of the first pair of keys is the second one in the row of the plurality of keys arranged from left to right.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A keyboard comprising:
a plurality of user-operable keys, comprising:
a first key; and
a second key disposed adjacent to the first key and arranged in a row with the first key; and
a processor for generating a first key signal representative of the first key in response to the key-in action of only the first key, generating a second key signal representative of the second key in response to the key-in action of only the second key, and generating the second key signal in response to the key-in action of the second key together with the first key.

2. The keyboard of claim 1, wherein the plurality of user-operable keys are arranged into a QWERTY array.

3. The keyboard of claim 1, wherein the first key is a wide key, and the second key is a narrow key.

4. The keyboard of claim 3, wherein the plurality of user-operable keys also comprises a third key, the third key is disposed adjacent to the second key and arranged in a row with the second key, the processor functions by generating a third key signal representative of the third key in response to the key-in action of only the third key, and generating the third key signal in response to the key-in action of the second key together with the third key.

5. The keyboard of claim 4, wherein a first distance between the first key and the second key is less than a second distance between the second key and the third key.

6. The keyboard of claim 4, wherein the third key is another wide key.

7. A handheld electronic apparatus, comprising:
a housing;
a keyboard, mounted in the housing, comprising a plurality of user-operable keys, the plurality of user-operable keys comprising:
a first key; and
a second key disposed adjacent to the first key and arranged in a row with the first key; and
a processor for generating a first key signal representative of the first key in response to the key-in action of only the first key, generating a second key signal representative of the second key in response to the key-in action of only the second key, and generating the second key signal in response to the key-in action of the second key together with the first key.

8. The handheld electronic apparatus of claim 7, wherein the plurality of user-operable keys are arranged into a QWERTY array.

9. The handheld electronic apparatus of claim 7, wherein the first key is a wide key, and the second key is a narrow key.

10. The handheld electronic apparatus of claim 9, wherein the plurality of user-operable keys also comprises a third key; the third key is disposed adjacent to the second key and arranged in a row with the second key, and the processor functions by generating a third key signal representative of the third key in response to the key-in action of only the third key, and generating the third key signal in response to the key-in action of the second key together with the third key.

11. The handheld electronic apparatus of claim 10, wherein a first distance between the first key and the second key is less than a second distance between the second key and the third key.

12. The handheld electronic apparatus of claim 10, wherein the third key is another wide key.

13. An inputting method by use of a keyboard comprising a plurality of user-operable keys, the plurality of user-operable keys being arranged into an array of M rows, M being an integer larger than one, the at least one row of keys in the M rows of keys being adjacent to each other and arranged continuously, the at least one row of keys comprising a first key and a second key, the second key being disposed adjacent to the first key, the method comprising the steps of:
in response to the key-in action of only the first key, generating a first key signal representative of the first key;
in response to the key-in action of only the second key, generating a second key signal representative of the second key; and
in response to the key-in action of the second key together with the first key, generating the second key signal.

14. The inputting method of claim 13, wherein the first key is a wide key, and the second key is a narrow key.

15. The inputting method of claim 13, wherein the first key is the first one in the at least one row of keys from right to left or from left to right, and the second key is the second one in the at least one row of keys from right to left or from left to right.

16. The inputting method of claim 13, wherein the plurality of user-operable keys also comprises a third key, and the third key is disposed adjacent to the second key; said method further comprising the steps of:
in response to the key-in action of only the third key, generating a third key signal representative of the third key; and
in response to the key-in action of the second key together with the third key, generating the third key signal.

17. A keyboard comprising:
a plurality of user-operable keys arranged in an array of M rows, M being an integer larger than one, at least some of the keys in the at least one row of keys among the M rows of keys being interlaced with wide keys and narrow keys.

18. The keyboard of claim 17, wherein the plurality of user-operable keys are arranged into a QWERTY array.

19. The keyboard of claim 18, wherein a wide key and a narrow key adjacent to each other are a pair of keys, and the distance between two pairs of keys is more than the distance between the wide key and the narrow key.

20. The keyboard of claim 17, wherein the plurality of user-operable keys comprises a pair of first keys and a pair of second keys, the pair of the first keys comprises a first wide key and a first narrow key, the first wide key is located at the right side of the first narrow key, the pair of the second keys comprises a second wide key and a second narrow key, and the second wide key is located at the left side of the second narrow key.
